(19) United States
(12) Patent Application Publication
(10) Pub. No.: US 2012/0073107 A1
(43) Pub. Date: Mar. 29, 2012

(54) CLAMPING DEVICE ON A VIBRATOR AND METHOD FOR CLAMPING A TUBE ON SAID CLAMPING DEVICE

(76) Inventors: Johannes Koecher, Kuenzell (DE); Uwe Richter, Alsfeld-Eudorf (DE); Dirk Ulrich, Alsfeld-Eudorf (DE)

(21) Appl. No.: 13/130,588

(22) PCT Filed: Feb. 10, 2010
(86) PCT No.: PCT/DE10/00151

§ 371 Date: Sep. 12, 2011

(30) Foreign Application Priority Data
Feb. 12, 2009 (DE) 10 2009 008 581.5

(51) Int. Cl. B23P 11/00; F16L 3/10

(52) U.S. Cl. 29/428; 248/70

(57) ABSTRACT

The invention relates to a clamping device on a vibrator, by means of which a pipe (11,12) is rammed into the ground. According to the invention, the clamping device is designed as a pipe collet chuck having at least two partial areas radially outwardly displaceable by means of one or more expanding elements (14, 15), wherein the length of the pipe collet chuck corresponds sub-stantially to the length of the pipe or pipe part to be rammed. The invention further relates to a me-thod for clamping the pipe using the clamping device indicated, which is inserted into the pipe along the entire length of the pipe, before the expanding elements of the pipe collet chuck are actuated for radially expanding for frictionally or positively contacting the internal wall of the pipe to be clamped.

The invention relates to a clamp with which a pipe, particularly a thin-walled pipe having a small diameter/length ratio is pile-driven into the ground, as well as to a method for clamping a pipe with the clamp without deforming or bending the pipe.

For driving steel beams, sheet piles, or also steel pipes, a vibration method is preferably used in which vertical vibrations are generated by a vibratory pile driver and transferred to the material to be pile-driven, which can be a sheet pile, for example, by a clamp. The vibrations that are generated excite the ground and cause it to assume a quasi-liquid state, thereby drastically reducing surface friction and the tip resistance of the material to be pile-driven. Because of the inherent weight of the assembly consisting of the sheet pile, the internal clamp, and the vibratory pile driver, the material is quickly and efficiently driven into the ground.

The clamps according to the prior the art for connecting the vibratory pile driver with the material to be pile-driven are configured as a grab whose jaws are adapted to the shape of the material to be driven. The jaws can therefore be flat for driving sheet piles having an at least partly flat side, or partly cylindrical for driving pipe.

For driving pipe, generally at least two axially symmetrical grippers are mounted below the vibratory pile driver if possible. The jaws of the grippers have circularly arcuate faces of a radius equal to the radius of the pipe to be driven. In case of pipe having a small diameter, there is the problem that the gripper jaws are too big to be able to together clamp a pipe.

For pipe having a small diameter, internal pipe clamps are used that are fitted around the pipe to be driven, like a pipe clamp, and are fixed in place on the outer pipe surface by a clamping cylinder. The clamps like pipe clamps have an inner surface whose radius is equal to the radius of the outer surface of the pipe to be clamped.

For thick-walled pipe such as concrete or wooden posts, a grab can be used whose clamping jaws apply the required clamping force on diametrally opposite sides to outer surfaces of the pipe or post. The disadvantage of such clamps is that with thin-walled pipes, the clamping forces are relatively great, so that the pipe can be plastically deformed.

In EP 0940506 [U.S. Pat. No. 6,582,158], an internal clamp is presented that is fitted inside a pipe, and the pipe is clamped to the clamp by expansion elements that are pressed against the inner surface of the pipe. Here again, there is the disadvantage that the clamping forces that engage at the upper end of the pipe deform the pipe there.

For all these clamps, it is true that, since they engage at the upper end of the pipe, with thin-walled pipe having a small diameter/length ratio there is a significant risk of bending the pipe as the result of the static top load or an increasing force additionally applied by a pile-driving guide support. This risk increases as the thickness of the pipe wall decreases. In general, thin-walled pipe is understood to be pipe having a wall thickness of 1 mm to 3 mm. The length of commercially available pipes is 4 m, for example and their diameter is 160 mm, so that the diameter/length ratio of this type of pipe is 0.04. A small diameter/length ratio in the sense of the present application is generally understood to be a value between 0.02 and 0.06. However, the bending resistance of a pipe when it is being driven into the ground is also dependent on the ground composition, where there is a greater risk of bending in the case of more solid ground or ground that contains small rocks.

It is the object of the present invention to further develop a clamp of the type described above that allows reliable, bend-free introduction of a pipe into the ground. This clamp is particularly supposed to be suitable for pipes having a small diameter, a small diameter/length ratio, as well as for thin-walled pipes. The pipe to be driven is intended to be securely fixed in place on the internal clamp.

To attain this object, the clamp according to claim 1 is proposed, which is characterized, according to the invention, in that the clamp is configured as an internal pipe clamp having at least two parts that can be moved radially outward by an expansion element or multiple expansion elements, the internal pipe clamp length essentially corresponding to the length of the pipe to be pile-driven or of the pipe part that is to be pile-driven into the ground. In contrast to what is usual in the state of the art, the internal clamp is engaged deep into the pipe to be fixed in place on the internal clamp, and therefore on the vibratory pile driver, and afterward, a friction fit or force fit with the inner pipe wall is produced by radial outward movement of the expansion elements. Basically, the clamp is also suitable for extracting pipe out of the ground, but this generally causes fewer problems than pile-driving, during which the risk of bending of the pipe is significantly greater, depending on the bending resistance of the pipe and the ground composition. Because of the extensively uniform application of pressure against the inner pipe surface, the pipe is significantly protected against damage.

The radially movable parts can be radially outwardly movable parts of the internal pipe clamp. Preferably, the parts that can be moved by expansion elements can be pressed against the inner surface of the pipe to be pile-driven or pulled, in a friction fit. As a result of the deep engagement of the internal clamp, sufficient clamping force without deformation of the pipe can be achieved, particularly in that the clamping force of the expansion elements is applied to the greatest possible friction-fit surface area, by means of this design. In an embodiment of the invention, the internal pipe clamp consists of a cylindrical housing in which are provided multiple hydraulic pistons having arcuate shell-shaped face surfaces can be moved radially outward and spaced along the longitudinal axis of the housing. As an alternative to this, it is also possible to provide a hydraulic piston-cylinder arrangement extending along the longitudinal axis of the internal pipe clamp, which arrangement acts on wedges of a pair of angled faces, which wedges allow radial outward displacement of wall parts of the pipe gripper. In a concrete illustrated embodiment, the internal pipe clamp can have two half shells that can be moved apart from one another by a hydraulic device. Preferably, the half shells have an outer radius that is the same size as the inner radius of the pipe to be clamped.

According to a particular embodiment of the invention, the expansion elements consist of hydraulic piston-cylinder arrangements that in particular extend transverse to the longitudinal axis of the internal pipe clamp. Frequently, the vibratory pile drivers described above are mounted on a guide support of a construction vehicle that has corresponding hydraulic lines and connections that can be used to operate the internal pipe clamp. A separate hydraulic unit can however also be used.

According to a further development of the invention, is multiple piston-cylinder arrangements mounted one after the other along the longitudinal axis of the internal pipe clamp are provided. The pistons, which preferably extend transversely, are radially moved out after engagement of the internal pipe clamp into the pipe, where, depending on the design, so many piston-cylinder arrangements can be present that the inner surface of the pipe can be clamped over its entire inner length. By means of such a configuration, thin-walled pipes in particular have a clamping pressure applied to them uniformly over their entire height, and this promotes shape stabilization of the pipe to be driven and counteracts undesirable deformations.

Furthermore, the internal pipe clamp according to the invention preferably has two or more tubular sections offset longitudinally and movable radially. If, according to another embodiment, the tubular sections are configured as part-cylindrical shells having an outer surface radius that is the same size or slightly smaller than the inner radius of the pipe to be pile-driven or pulled, an ideal full-surface contact of the radially movable tubular sections against the inner surface of the pipe to be pile-driven or pulled can be created.

According to a further development of the invention, the expansion device has a coupling gear mechanism driven by a hydraulic cylinder, or an arrangement of rails that slide on one another, with angled faces provided one behind the other. Such embodiments permit precise guidance of the expansion device, which is robust and not susceptible to wear.

In the case of thin pipes that are to be pile-driven into the ground, there is the risk that deformation of the pipe end can occur because of the low resistance moment of the pipe, due to the tip pressure that occurs during pile-driving and in the event of hindrances such as stones, and under some circumstances, the planned depth to which the pipe is to be pile-driven cannot be reached because of this deformation. Also, the deformation of the pipe can bring about the result that a sufficient static support function no longer exists. In order to remedy these disadvantages, according to a further development of the invention, the free end of the internal pipe clamp is provided with a conical tip that is protected against wear.

When used, this tip has the purpose of protecting the internal pipe clamp in the clamped state. For this purpose, the internal clamp with tip is engaged into the pipe so far that the tip projects beyond the pipe end. As a precaution, the remaining region between the greatest diameter of the tip and the inner pipe wall should still be sealed off with a flexible or elastic mass. This prevents soil from getting into the pipe interior as the pipe is advanced; this soil could possibly damage the internal pipe clamp there, or cause excessive wear. It is practical if the tip is provided with wear protection on the front, for example with armoring or hard metal pins.

A possibility of sealing off the annular gap between the pipe to be driven and the post internal clamp consists in giving the tip a shape such that it has a cylindrical outer surface, onto which an elastic sealing ring can be pushed, for example an O-ring. When the pipe is held by the internal clamp, the tip is pushed beyond the pipe end so far that the region of the cylindrical surface lies axially level with the pipe end.

Subsequently, the O-ring is pushed onto the cylindrical outer surface of the tip from below. The inside diameter of the O-ring or of the elastic sealing ring is slightly smaller than the outside diameter of the outer surface of the tip, so that when the sealing ring is pushed on, it grips the outer surface and cannot slip off. The outside diameter of the O-ring or of the elastic sealing ring is slightly greater than the inside diameter of the pipe, taking tolerances into consideration. By means of this arrangement, the sealing ring is pressed into the annular gap between internal clamp and pipe when the pipe is driven into the ground, so that no soil can penetrate.

Another advantageous embodiment provides that the internal pipe clamp has a cylindrical section in its lower region, in front of the tip whose diameter is slightly smaller than the inside diameter of the pipe to be clamped. An expandable elastic material is set in an annular-shaped groove-like depression in this region. Radial pressure is applied to the elastic medium in the groove by a supply line in the internal clamp, by a gaseous or liquid medium that expands the elastic material to such an extent that it is pressed against the inner surface of the pipe and thus seals off the annular gap between pipe and internal clamp, to prevent soil from entering.

Preferably, sealing can be done hydraulically, so that the clamping function and the sealing function take place simultaneously, by one supply line.

According to another embodiment, the method according to claim 12 is used to clamp a pipe on a clamp. According to this method, the internal pipe clamp is engaged into the pipe and subsequently the expansion elements of the internal pipe clamp are activated to radially spread the parts of the internal pipe clamp until they make contact with the inner surface of the pipe to be clamped in a friction or shape fit so that the pipe has the internal pipe clamp applied to it at least essentially over its entire length or over the length to be lowered into the ground.

As already mentioned above, the internal pipe clamp provided with a tip can be engaged into the pipe all the way to the lowermost section, so that the wear-protected tip projects beyond the pipe end before the expansion elements are activated. The tip then serves as protection for the internal pipe clamp.

The internal pipe clamp therefore serves as a type of expansion mandrel by which the vibrations of the vibratory pile driver are transferred to the pipe to be driven.

Embodiments of the invention are shown in the drawings.

### Therein:

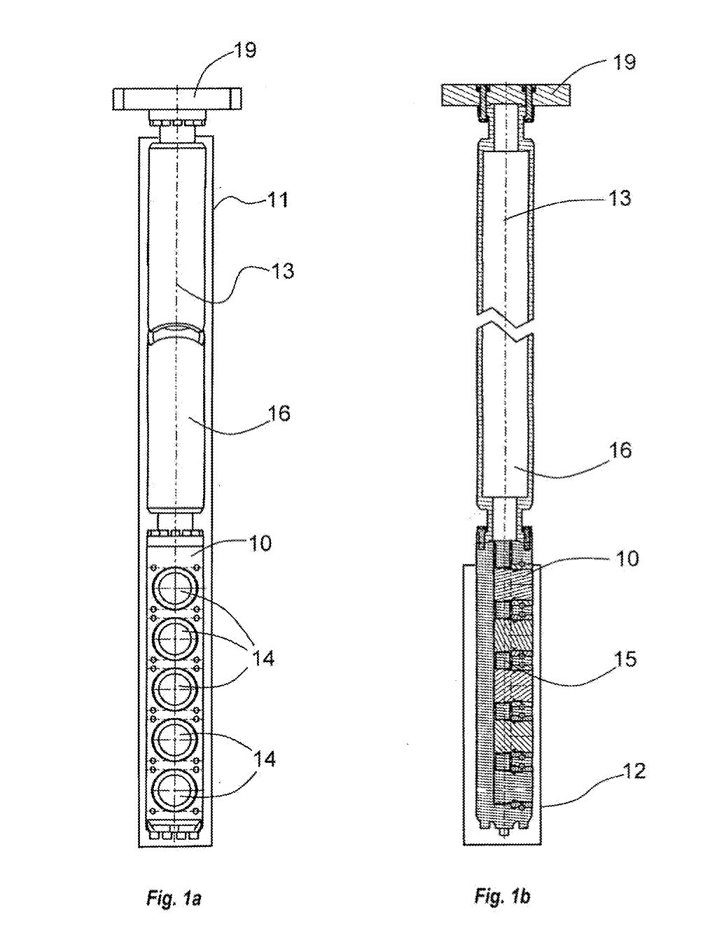

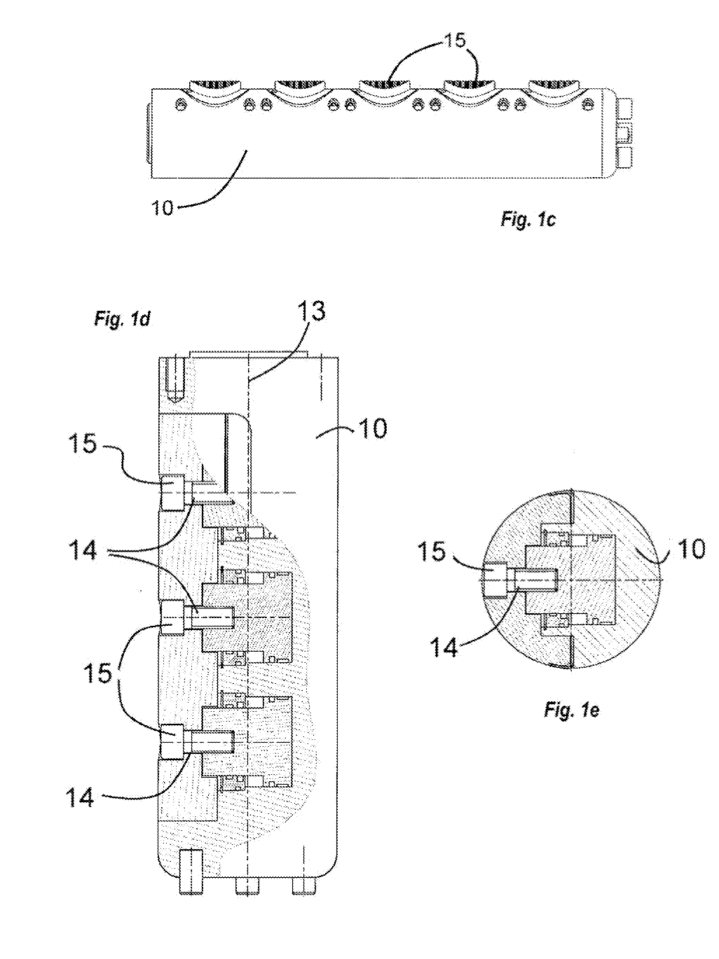

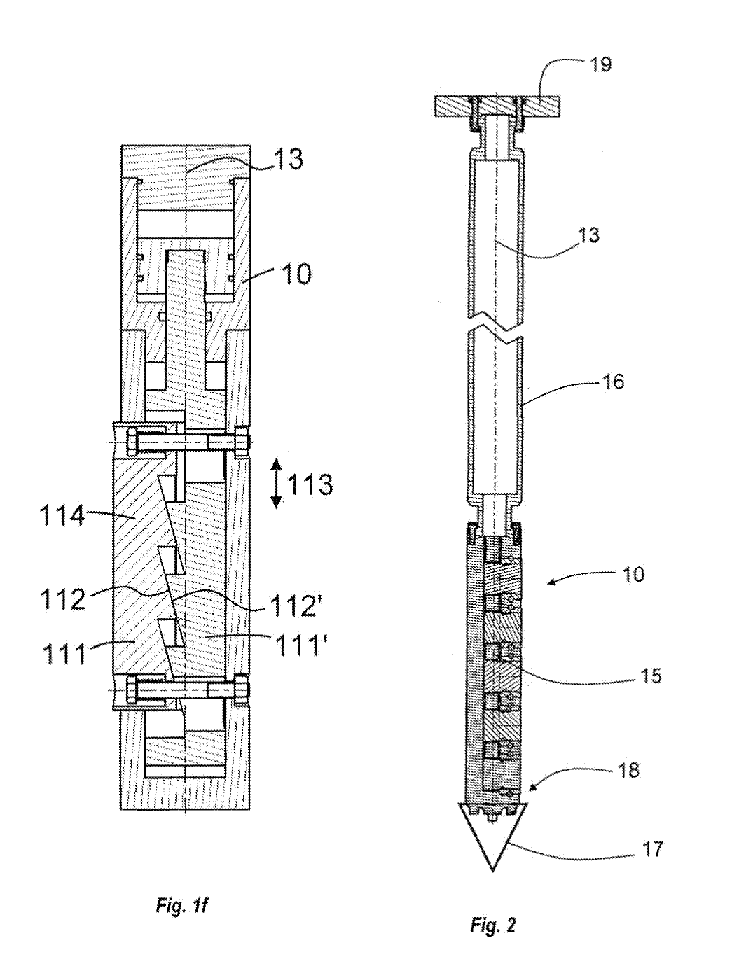

FIG. 1a is a side view of a clamp according to the invention,

FIG. 1b is a section through the same clamp,

FIG. 1c is a side view of an internal clamp,

FIGS. 1d and 1e are a partly section side view and an end view of the internal clamp according to FIG. 1c,

FIG. 1f shows an alternative embodiment of an internal clamp, and

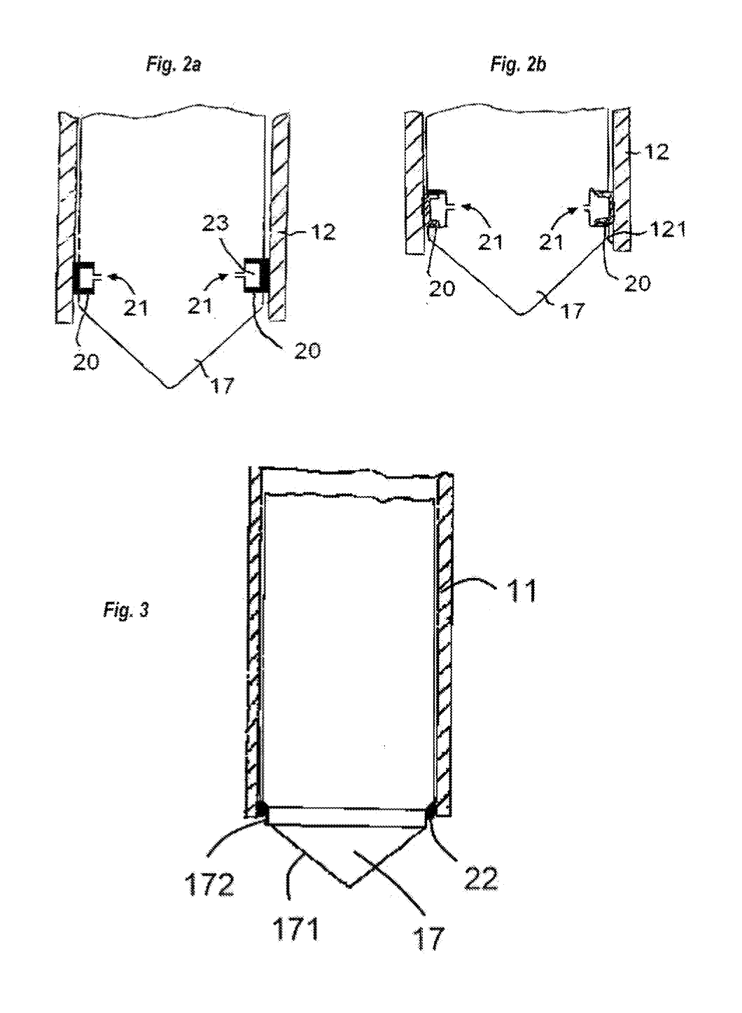

FIG. 2 shows another embodiment of the clamp according to FIG. 1 with a point,

FIG. 2a is a part-sectional view of the pointed clamp inserted into a pipe without sealing the annular gap, and

FIG. 2b is the same part-sectional view as FIG. 2a with a sealed annular gap between clamp and pipe, and

FIG. 3 is a part-sectional view of the clamp with its point fitted with an O-ring.

The internal pipe clamp shown in the figures consists of a cylindrical housing 10 whose diameter is slightly smaller than the inside diameter of a long or short pipe 11 or 12 to be driven. At least one cylinder, preferably multiple cylinders 14 as shown are affixed one on top of the other at planes perpendicular to a cylinder axis 13. Pistons in these cylinders can be activated hydraulically and moved out transverse to the axis beyond the outer surface of the cylinder [cylindrical housing 10], so that they move one movable part 15 or multiple parts radially outward. The part 15 is formed by a part-cylindrically curved piston face. Radial movement of the pistons presses the parts 15 against the inner surface of the pipe 11 or 12, and the pipe is thus locked to the clamp, as the part-cylindrical face that faces away from the piston comes to lie against the opposite pipe inside surface.

Alternatively, tubular sections of the clamp that are separated longitudinally are radially pressed apart from one another inside the pipe 11 or 12 to be clamped, particularly by a coupling drive driven by a hydraulic linear cylinder or an arrangement (see FIG. 1e) of wedge rails 111, 111′ that slide on one another, having angled faces 112, 112′ that are provided one behind the other. In this connection, the strip 111′ is guided in the direction of the arrow 113, so that the angled faces 112, 112′ slide on one another. Because of the wedge shape, the part 14 is pressed radially outward. Alternatively, two half shells of multiple integrated hydraulic pistons can also be pressed apart from one another.

Because of the radial movement of the parts there is a relatively large clamping surface so that the clamping force applies a low surface pressure on the inner pipe surface. Because of the configuration of the internal clamp cylinder according to the invention, with a slightly smaller outside diameter than the inside diameter of the pipe, plastic deformation of the pipe 11, 12 is furthermore prevented.

A significant advantage of the internal clamp described lies in that pipes having a greater length 11 than the cylinder length of the internal clamp 10 can be clamped by using an extension 16 as shown in the drawings so that clamping takes place in the lower region of the pipe. In this way, the lower region of the pipe is reinforced and the upper region of the pipe is protected against bending in that it is driven being pulled.

In FIG. 2, a tip 17 at the lower end of the clamp is shown that prevents deformation of the pipe wall by high peak resistance and barriers.

To secure the clamp on the pipe, first the clamp 11 [10], if applicable with the extension 16, is engaged into the pipe, and subsequently the piston-cylinder arrangement is activated.

The tip 17 can preferably be armored with hard metal pins, thereby reducing wear and helping to easily overcome disruptions in soil that is actually capable of vibration, such as those that can be caused by stones or more solid layers.

The clamp or the extension 16 is connected with a vibratory pile driver by a connection plate 19. The vibratory pile driver can generate vertical vibrations that are transferred to the pipe to be driven in or pulled out through the clamp.

As shown schematically in FIGS. 2a and 2b or FIG. 3, penetration of soil into the annular gap between the clamp and the inner pipe surface 11 or 12, can be prevented by a seal 20 or 22. In the embodiment according to FIGS. 2a and 2b, the tip 17 has a cylindrical transition region having an annular groove 23 in which a U-section seal to which pressure can be applied from the inside of the tip, as shown in FIGS. 2a and 2b with arrows 21. When pressure is applied to such a seal, it moves from the retracted position according to FIG. 2a, in which it ends essentially flush with the outer surface of the cylinder, into a position in which it lies against the inner pipe surface 121 of the pipe 12, forming a seal. Such seals are produced from elastomers and return to the starting condition shown in FIG. 2a as soon as the pressure application is eliminated.

A technical alternative embodiment of an O-ring seal 22 is shown in FIG. 3. In this case, an O-ring is pushed onto the tip 17, along its conical surface 171, to where the O-ring is spread to such an extent until it lies in the position shown in FIG. 3, with friction fit, thereby sealing the annular gap between the pipe 11 and the cylindrical part 172 of the tip. Pushing this ring on preferably is done after the clamp has been completely engaged into the pipe 11. The O-ring must be adapted to the maximum diameter of the tip with regard to its elasticity as well as its hardness and dimensions.

1. A clamp on a vibratory pile driver with which a thin-walled pipe having a small diameter/length ratio is pile-driven into the ground, wherein the clamp is an internal pipe clamp having at least two parts that can be moved radially outward by one or more expansion elements, the internal pipe clamp length essentially corresponding to the length of the pipe or pipe part that is to be pile-driven.

2. The clamp according to claim 1, wherein the parts that can be moved by expansion elements can be pressed against the inner surface of the pipe to be driven or pulled for a friction fit.

3. The clamp according to claim 1, wherein the expansion element consists of a hydraulic piston-cylinder arrangement preferably extending transverse to the longitudinal axis of the internal pipe clamp.

4. The clamp according to claim 3, wherein multiple piston-cylinder arrangements next to one another are provided along a longitudinal axis of the internal pipe clamp.

5. The clamp according to claim 1, wherein the internal pipe clamp has two or more longitudinally offset tubular sections that are radially movable.

6. The clamp according to claim 5, wherein the tubular sections each have a round outer part-cylindrical surface whose radius is the same or slightly smaller than the inner radius of the pipe to be pile-driven or pulled.

7. The clamp according to claim 1, wherein the expansion device has a coupling gear mechanism driven by a hydraulic cylinder or an arrangement of rails that slide on one another and have angled faces provided one after the other.

8. The clamp according to claim 1, wherein the free internal pipe clamp end has a wear-protected conical tip that is armored or reinforced with hard metal pins.

9. The clamp according to claim 1, wherein a seal that can be spread elastically is provided on the front end to seal off an annular gap between the pipe to be driven and the clamp, or a seal ring whose inside diameter is preferably slightly smaller than the diameter of the outer surface of the tip thereof, and whose outside diameter is slightly larger than the inside diameter of the pipe to be driven is pushed on.

10. The clamp according to claim 9, wherein the seal ring lies on a cylindrical surface or partly, with its cross-section, in a groove of the outer surface of the clamp.

11. The clamp according to claim 9, wherein widening of the elastic seal is done hydraulically, preferably with the same hydraulic device with which the clamp can also be activated.

12. A method for clamping a pipe on a clamp according to claim 1, in which method the internal pipe clamp is engaged into the pipe over the entire length of the pipe, and subsequently the expansion elements of the internal pipe clamp are activated to radially spread the parts of the internal pipe clamp until they make contact with the inner surface of the pipe to be clamped with a friction or shape fit so that the pipe has the internal pipe clamp applied to it at least essentially over its entire length or over the portion of its length to be inserted down into the ground.

13. The method according to claim 12, that wherein the internal pipe clamp is engaged into the pipe all the way to the lowermost section, so that the tip projects beyond the pipe end, before the expansion elements are activated.
